(19) United States
(12) Patent Application Publication
(10) Pub. No.: US 2014/0042846 A1
(43) Pub. Date: Feb. 13, 2014

(54) MOTOR HOUSING

(71) Applicant: SAMSUNG ELECTRO-MECHANICS CO., LTD., Gyunggi-do (KR)

(72) Inventors: Myung Geun Oh, Gyunggi-do (KR); Yong Wan Cho, Gyunggi-do (KR); Sang Ho Seo, Gyunggi-do (KR); Sung Tai Jung, Gyunggi-do (KR); Jung Kyu Yim, Gyunggi-do (KR)

(73) Assignee: SAMSUNG ELECTRO-MECHANICS CO., LTD., Gyunggi-do (KR)

(21) Appl. No.: 13/707,570

(22) Filed: Dec. 6, 2012

(30) Foreign Application Priority Data
Aug. 13, 2012 (KR) 10-2012-0088341

(51) Int. Cl. H02K 5/22

(52) U.S. Cl. CPC H02K 5/22
USPC 310/89

(57) ABSTRACT

Disclosed herein is a motor housing including: a housing body accommodating a stator and a rotor therein; and a supporting frame coupled to the housing body and supporting a shaft of the rotor, wherein an end portion of the housing body is provided with a fixing part that is extended inwardly, such that the supporting frame is coupled to the fixing part.

### CROSS REFERENCE TO RELATED APPLICATION

This application claims the benefit of Korean Patent Application No. 10-2012-0088341, filed on Aug. 13, 2012, entitled “Motor Housing”, which is hereby incorporated by reference in its entirety into this application.

### BACKGROUND OF THE INVENTION

1. Technical Field

The present invention relates to a motor housing.

2. Description of the Related Art

In general, a motor is provided with a housing accommodating a stator and a rotor of the motor as described in Korea Patent Laid-Open Publication No. 2007-0002541.

In this configuration, the housing is configured of a pair of upper and lower housings, wherein the lower housing accommodates the stator and the rotor therein and the upper housing is formed so as to cover an upper portion of the lower housing.

In this configuration, the lower housing has an upper end outwardly extended so as to mount a supporting frame member supporting a shaft of the rotor thereon.

Therefore, an outer diameter of the upper housing coupled to the upper end of the lower housing increases, such that the entire outer diameter of the housing increases, thereby making it difficult to miniaturize the motor.

### PRIOR ART DOCUMENT

### Patent Document

(Patent Document 1) Korea Patent Laid-Open Publication No. 2007-000254

### SUMMARY OF THE INVENTION

The present invention has been made in an effort to provide a motor housing capable of having a reduced outer diameter by inwardly extending an end portion of one of a pair of motor housings.

Further, the present invention has been made on an effort to provide a motor housing capable of guiding a coupling position at the time of coupling a supporting frame supporting a shaft of a motor to one of a pair of motor housings by forming a guide hole in one of the pair of motor housings.

According to a preferred embodiment of the present invention, there is provided a motor housing including: a housing body accommodating a stator and a rotor therein; and a supporting frame coupled to the housing body and supporting a shaft of the rotor; wherein an end portion of the housing body may be provided with a fixing part that is extended inwardly, such that the supporting frame may be coupled to the fixing part.

The motor housing may further include a fixing member fixing the supporting frame to the fixing part.

The fixing part may be formed by being bent from the housing body by a press process.

The fixing part may be provided with guide holes and the supporting frame may be provided with guide protrusions corresponding to the guide holes, such that the guide protrusions may be inserted into the guide holes at the time of coupling the supporting frame to the fixing part.

The guide protrusions may be disposed at the same interval along a circumferential path.

The motor housing may further include a housing cover covering one side of the housing body, wherein the housing body may be opened in one side direction thereof

The housing cover may be coupled to an outer peripheral surface of the housing body.

The housing cover may have an accommodating space formed at an inner side thereof and an introducing hole formed at the central portion thereof, such that at the time of rotating an impeller accommodated in the accommodating space and coupled to an end portion of the shaft, air may be introduced into the accommodating space through the introducing hole.

The housing cover may include a discharging hole formed at a side portion thereof; such that the air introduced through the introducing hole may be discharged through the discharging hole.

The housing cover may include a discharging hole formed at a side portion thereof; such that the air introduced through the introducing hole may be discharged through the discharging hole.

According to another preferred embodiment of the present invention, there is provided a motor housing including: a housing body accommodating a stator and a rotor therein; a supporting frame coupled to the housing body and supporting a shaft of the rotor; and a fixing member fixing the supporting frame, wherein an end portion of the housing body is provided with a fixing part that is extended inwardly, such that the supporting frame is coupled to the fixing part, and the fixing part may be provided with a first fixing hole and the supporting frame may be provided with a second fixing hole corresponding to the first fixing hole, such that the fixing member may be coupled to the first fixing hole and the second fixing hole.

The fixing part may be provided with a guide hole and the supporting frame may be provided with a guide protrusion corresponding to the guide hole, such that at the time of coupling the supporting frame to the fixing part, the guide protrusion may be inserted into the guide hole.

The guide protrusions may be disposed at the same interval along a circumferential path.

The fixing part may be formed by being bent from the housing body by a press process.

The motor housing may further include a housing cover covering one side of the housing body, wherein the housing body may be opened in one side direction thereof

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a motor housing according to a preferred embodiment of the present invention;

FIG. 2 is a cross-sectional view showing the motor housing according to the preferred embodiment of the present invention;

FIG. 3 is a perspective view showing a housing body and a supporting frame in the motor housing according to the preferred embodiment of the present invention;

FIG. 4 is an exploded perspective view showing the housing body and the supporting frame in the motor housing according to the preferred embodiment of the present invention; and

FIG. 5 is a perspective view showing the housing body in the motor housing according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

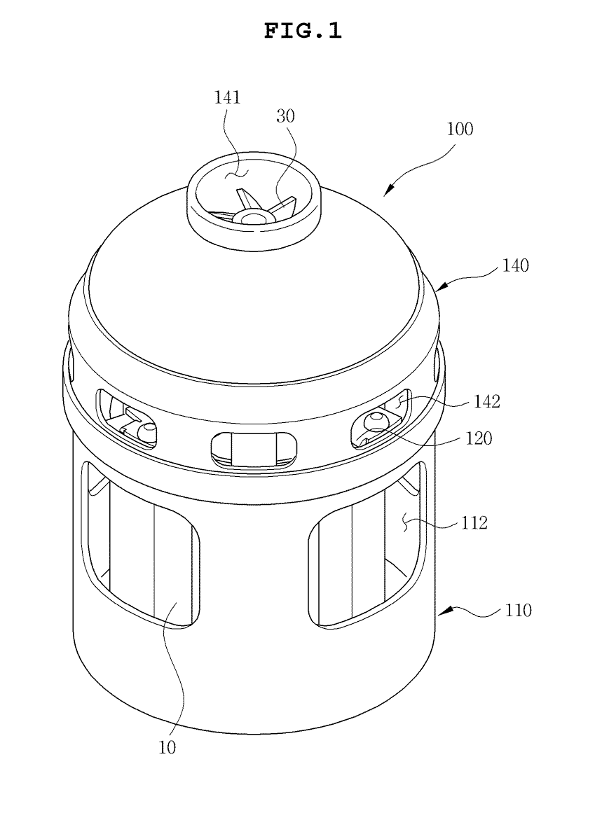

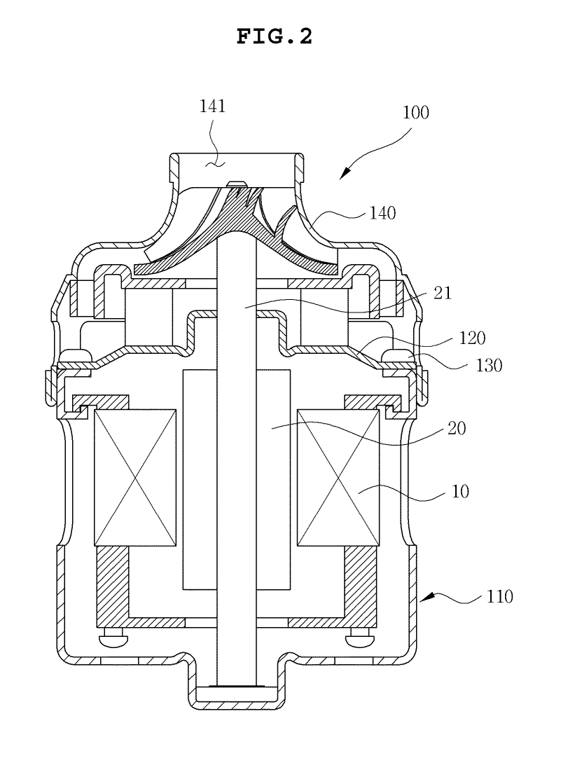

FIG. 1 is a perspective view showing a motor housing according to a preferred embodiment of the present invention; and FIG. 2 is a cross-sectional view showing the motor housing according to the preferred embodiment of the present invention.

Referring to FIGS. 1 and 2, a motor housing motor 100 according to the preferred embodiment of the present invention includes a housing body 110 in which a fixing part 111 is formed and a supporting frame 120. In addition, the motor housing 100 according the preferred embodiment of the present invention may further include a housing cover 140 and a fixing member 130.

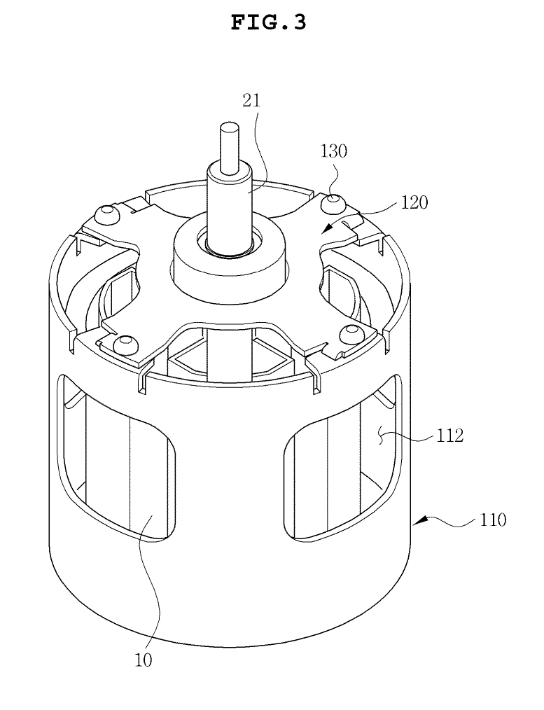

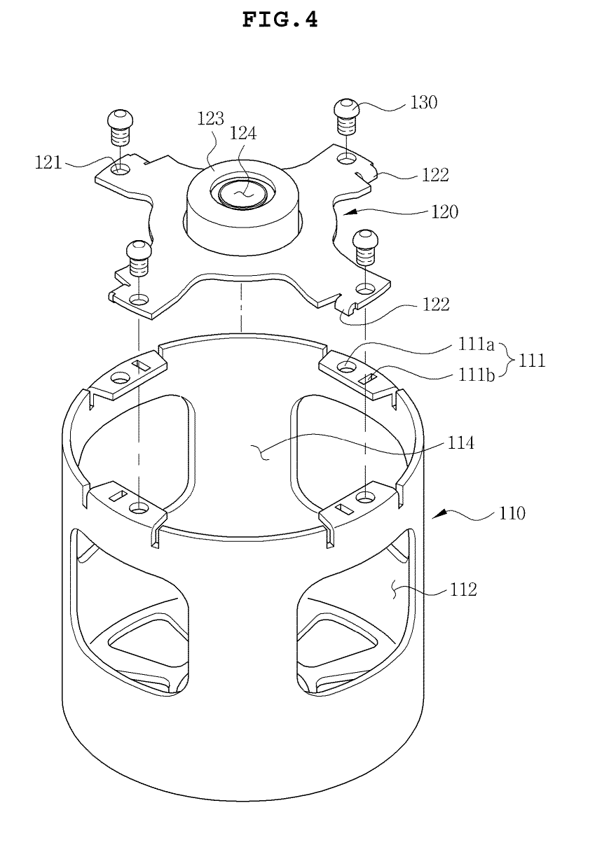

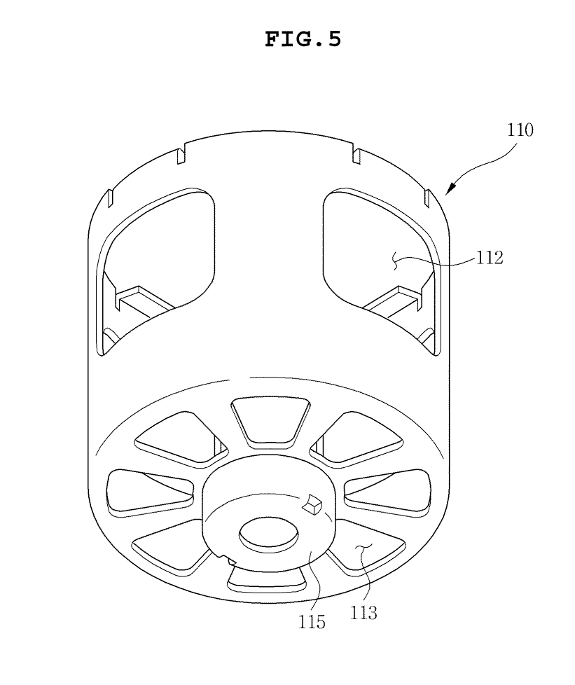

FIG. 3 is a perspective view showing a housing body and a supporting frame in the motor housing according to the preferred embodiment of the present invention; FIG. 4 is an exploded perspective view showing the housing body and the supporting frame in the motor housing according to the preferred embodiment of the present invention; and FIG. 5 is a perspective view showing the housing body in the motor housing according to the preferred embodiment of the present invention.

Hereinafter, the motor housing 100 according to the preferred embodiment of the present invention will be described in more detail with reference to FIGS. 1 to 5.

First referring FIGS. 3 to 5, the housing body 110 includes an accommodating part 114 formed at an inner side thereof, wherein the accommodating part 114 is a space in which a stator 110 of the motor and a rotor 20 of the motor including a shaft 21 are accommodated.

In addition, the housing body 110 has a cylindrical form opened at one side thereof and has a discharging hole 112 formed in a side portion thereof, wherein the discharging hole 112 penetrates through the inner and outer sides of the housing body 110. Here, a plurality of discharging holes 112 may be included. As an example, four discharging holes 112 may be formed at four portions of the housing body 110, respectively.

In addition, a lower side portion of the housing body 110 is provided with jig holes 113 penetrating through the inner and outer sides of the housing body 110, such that at the time of a press process of forming the fixing part 111 by bending an upper end portion of the housing body 110, it is easy to insert a jig into the housing body 110 from a lower side direction to position the jig at the bent portion.

Here, each of the upper side and the lower side of the housing body 110 indicates an upper side direction and a lower side direction based on the housing body 110 shown in FIGS. 3 and 4 as an example. However, the present invention is not limited thereto.

In addition, a lower portion of the housing body 110 may be provided with a first bearing 115 to rotatably support a lower portion of the shaft 21.

The fixing part 111 is extended inwardly from the upper end portion of the housing body 110. Here, the fixing part 111 may be extended in a rectangular shape from the housing body 110 and may be bent at a right angle toward the central axis of the housing body 110 by the press process to thereby be horizontally positioned. Here, the fixing part 111 may be formed in a “ [symbol] ” shape as an example. However, the shape of the fixing part 111 according to the preferred embodiment of the present invention is not necessarily limited thereto.

In addition, the fixing part 111 includes a first fixing hole 111a formed at one side thereof and a guide hole 111b formed at another side thereof Here, the first fixing hole 111a and the guide hole 111b are formed so as to vertically penetrate through the fixing part 111. In addition, the first fixing hole 111a has a lateral cross-section formed in a circular shape and is provided with a screw hole along an inner peripheral surface thereof, and the guide hole 111b is formed in a rectangular shape. However, the present invention is not necessarily limited thereto.

In addition, a plurality of fixing parts 111 may be extended from the housing body 110, respectively. As an example, four fixing parts 111 may be extended from four portions of the housing body 110, respectively.

The supporting frame 120 is coupled to the fixing part 111, thereby supporting the shaft 21 of the rotor 20 accommodated in the accommodating part 114 of the housing body 110.

In addition, the central portion of the supporting frame 120 is provided with a second bearing 123, thereby rotatably supporting the shaft 21. In this configuration, the central portion of the second bearing 123 is provided with a supporting hole 124 and the shaft 21 is inserted into the supporting hole 124.

In addition, the supporting frame 120 is extended from the central portion thereof in four directions, such that end portions thereof extended in four directions are fixed to four fixing parts 111 of the housing body 110 extended in four directions by the fixing members 130, respectively.

In this configuration, the supporting frame 120 includes a second fixing hole 121 formed at one side of an end portion thereof; such that the fixing member 130 is coupled to the first fixing hole 111a of the fixing part 111 through the second fixing hole 121.

Here, the fixing member 130 is, for example, a screw and the second fixing hole 121 has a screw part formed on an inner peripheral surface thereof; such that the screw that is the fixing member 130 may be screwed to the first fixing hole 111a and the second fixing hole 121, thereby making it possible to fix the supporting frame 120 to the fixing part 111.

In addition, the supporting frame 120 includes a guide protrusion 122 formed at the other side of the end portion thereof; wherein the guide protrusion 122 is inserted into the guide hole 111b formed in the fixing part. Here, at the time of coupling the supporting frame 120 to the housing body 110, the guide protrusion 122 formed at the supporting frame 120 is guided by the guide hole 111b, thereby making it possible to fix the supporting frame 120 at an accurate position.

In addition, the guide protrusions 122 may be disposed at the same interval along a circumferential path.

Here, the guide hole 111b and the guide protrusion 112 have a plane cross-section formed to correspond to each other. In this configuration, for example, the plane cross-sections of the guide hole 111b and the guide protrusion 112 may have a rectangular shape.

Meanwhile, the supporting frame 120 may be made of; for example, a metal material. However, the present invention is not limited thereto.

Referring to FIGS. 1 and 2, the housing cover 140 is coupled to the upper portion of the housing body 110 so as to cover the upper portion of the housing body 110.

In addition, the housing cover 140 has an accommodating space formed at an inner side thereof and an introducing hole 141 formed at the central portion thereof.

In addition, the housing cover 140 has a plurality of discharging holes 142 formed on side portion thereof.

In addition, an impeller 30 is accommodated in the accommodating space of the housing cover 140, such that air is introduced into the accommodating space of the housing cover 140 through the introducing hole 141 by rotation of the impeller 30.

Here, a portion of the air introduced into the accommodating space of the housing cover 140 may be discharged through the discharging hole 142 and the other portion thereof may be discharged through the discharging hole 112 of the housing body 110.

Meanwhile, the impeller 30 may be coupled to, for example, an end portion of the shaft 21 to thereby be rotated by the rotation of the shaft 21.

In addition, a lower portion of the housing cover 140 may be fitted into an upper outer peripheral surface of the housing body 110. In this configuration, a diameter of a lower inner peripheral surface of the housing cover 140 may be the same as or smaller than that of the upper outer peripheral surface of the housing body 110.

According to the preferred embodiment of the present invention, the end portion of one of the pair of the motor housings is inwardly extended, thereby making it possible to minimize the outer diameter of the housing.

In addition, according to the preferred embodiment of the present invention, the guide hole is formed at one of the pair of the motor housings to guide the coupling position at time of coupling the supporting frame supporting the shaft of the motor to one the pair of housings, thereby making it possible to prevent the occurrence of the defect in the product due to the inaccurate coupling.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A motor housing comprising:
a housing body accommodating a stator and a rotor therein; and
a supporting frame coupled to the housing body and supporting a shaft of the rotor;
wherein an end portion of the housing body is provided with a fixing part that is extended inwardly, such that the supporting frame is coupled to the fixing part.

2. The motor housing as set forth in claim 1, further comprising a fixing member fixing the supporting frame to the fixing part.

3. The motor housing as set forth in claim 1, wherein the fixing part is formed by being bent from the housing body by a press process.

4. The motor housing as set forth in claim 1, wherein the fixing part is provided with guide holes and the supporting frame is provided with guide protrusions corresponding to the guide holes, such that the guide protrusions are inserted into the guide holes at the time of coupling the supporting frame to the fixing part.

5. The motor housing as set forth in claim 4, wherein the guide protrusions are disposed at the same interval along a circumferential path.

6. The motor housing as set forth in claim 1, further comprising a housing cover covering one side of the housing body, wherein the housing body is opened in one side direction thereof.

7. The motor housing as set forth in claim 6, wherein the housing cover is coupled to an outer peripheral surface of the housing body.

8. The motor housing as set forth in claim 6, wherein the housing cover has an accommodating space formed at an inner side thereof and an introducing hole formed at the central portion thereof, such that at the time of rotating an impeller accommodated in the accommodating space and coupled to an end portion of the shaft, air is introduced into the accommodating space through the introducing hole.

9. The motor housing as set forth in claim 8, wherein the housing cover includes a discharging hole formed at a side portion thereof, such that the air introduced through the introducing hole is discharged through the discharging hole.

10. The motor housing as set forth in claim 8, wherein the housing cover includes a discharging hole formed at a side portion thereof, such that the air introduced through the introducing hole is discharged through the discharging hole.

11. A motor housing comprising:
a housing body accommodating a stator and a rotor therein;
a supporting frame coupled to the housing body and supporting a shaft of the rotor; and
a fixing member fixing the supporting frame,
wherein an end portion of the housing body is provided with a fixing part that is extended inwardly, such that the supporting frame is coupled to the fixing part, and
the fixing part is provided with a first fixing hole and the supporting frame is provided with a second fixing hole corresponding to the first fixing hole, such that the fixing member is coupled to the first fixing hole and the second fixing hole.

12. The motor housing as set forth in claim 11, wherein the fixing part is provided with a guide hole and the supporting frame is provided with a guide protrusion corresponding to the guide hole, such that at the time of coupling the supporting frame to the fixing part, the guide protrusion is inserted into the guide hole.

13. The motor housing as set forth in claim 12, wherein the guide protrusions are disposed at the same interval along a circumferential path.

14. The motor housing as set forth in claim 11, wherein the fixing part is formed by being bent from the housing body by a press process.

15. The motor housing as set forth in claim 11, further comprising a housing cover covering one side of the housing body, wherein the housing body is opened in one side direction thereof.
